(19) United States
(12) Patent Application Publication
(10) Pub. No.: US 2020/0012988 A1
(43) Pub. Date: Jan. 9, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Atsushi ITO, Kanagawa (JP); Jun SHINGU, Kanagawa (JP)

(73) Assignee: FUJI XEROX CO., LTD., Tokyo (JP)

(21) Appl. No.: 16/447,967

(22) Filed: Jun. 21, 2019

(30) Foreign Application Priority Data
Jul. 3, 2018 (JP) 2018-126566

(51) Int. Cl. G06Q 10/06; G06F 16/2457; G06F 16/248

(52) U.S. Cl. CPC G06Q 10/06398; G06F 16/248; G06F 16/24578

(57) ABSTRACT

An information processing apparatus includes a storage section that stores artwork information related to each of plural artworks and a connection relationship among the plural artworks, a specifying section that specifies an artwork in the connection relationship with an artwork selected by a user among the plural artworks from the relationship stored in the storage section, and a presentation section that ranks an artist of the artwork specified by the specifying section and presents a result of ranking.

### CROSS-REFERENCE TO RELATED APPLICATIONS

This application is based on and claims priority under 35 USC 119 from Japanese Patent Application No. 2018-126566 filed Jul. 3, 2018.

### BACKGROUND

### (i) Technical Field

The present invention relates to an information processing apparatus and a non-transitory computer readable medium storing a program.

### (ii) Related Art

A management system disclosed in, for example, JP2005-011075A is a system that manages technologies of staff members of a company. The management system evaluates skills of each staff member of the company with respect to an item of engineering technology, registers an evaluation score, and generates a skill map for each staff member. In addition, the management system correlates a skill necessary for productization with a priority as a coefficient and generates a skill map for each product. Based on the skill map, skills are analyzed for each staff member or each product, and skills in the technologies possessed by the company are evaluated.

### SUMMARY

In the field of engineering, skills possessed by a staff member may be evaluated from a career, a work history, or the like. Thus, by registering the career or the work history for each staff member and performing a search using the registered information, a staff member who has a necessary skill may be extracted from plural staff members. Meanwhile, for example, in the field of design, in a case where a staff member who may provide a desired artwork is searched, there is an element such as a taste of an artwork or an idea of a design that may not be evaluated using skills, and it is difficult to determine whether a staff member may produce the desired artwork using the career or the work history.

Aspects of non-limiting embodiments of the present disclosure relate to an information processing apparatus and a non-transitory computer readable medium storing a program extracting a person providing a desired artwork from plural persons.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a storage section that stores artwork information related to each of a plurality of artworks and a connection relationship among the plurality of artworks, a specifying section that specifies an artwork in the connection relationship with an artwork selected by a user among the plurality of artworks from the relationship stored in the storage section, and a presentation section that ranks an artist of the artwork specified by the specifying section and presents a result of ranking.

### BRIEF DESCRIPTION OF THE DRAWINGS

Exemplary embodiment(s) of the present invention will be described in detail based on the following figures, wherein:

FIG. 1 is a diagram illustrating apparatuses related to a talent search system 1 of one exemplary embodiment of the present invention;

FIG. 2 is a block diagram illustrating a hardware configuration of a server apparatus 10;

FIG. 3 is a diagram for describing a graph structure stored in a second database DB2;

FIG. 4 is a function block diagram illustrating functions implemented by causing a control unit 101 to execute a program;

FIG. 5 is a diagram illustrating one example of a Web page on which information related to an artwork is registered;

FIG. 6 is a diagram illustrating the graph structure to which a node is added;

FIG. 7 is a diagram illustrating one example of a screen displayed by a terminal apparatus; and

FIG. 8 is a flowchart illustrating a flow of process performed by the server apparatus 10.

### DETAILED DESCRIPTION

### Exemplary Embodiment

Overall Configuration

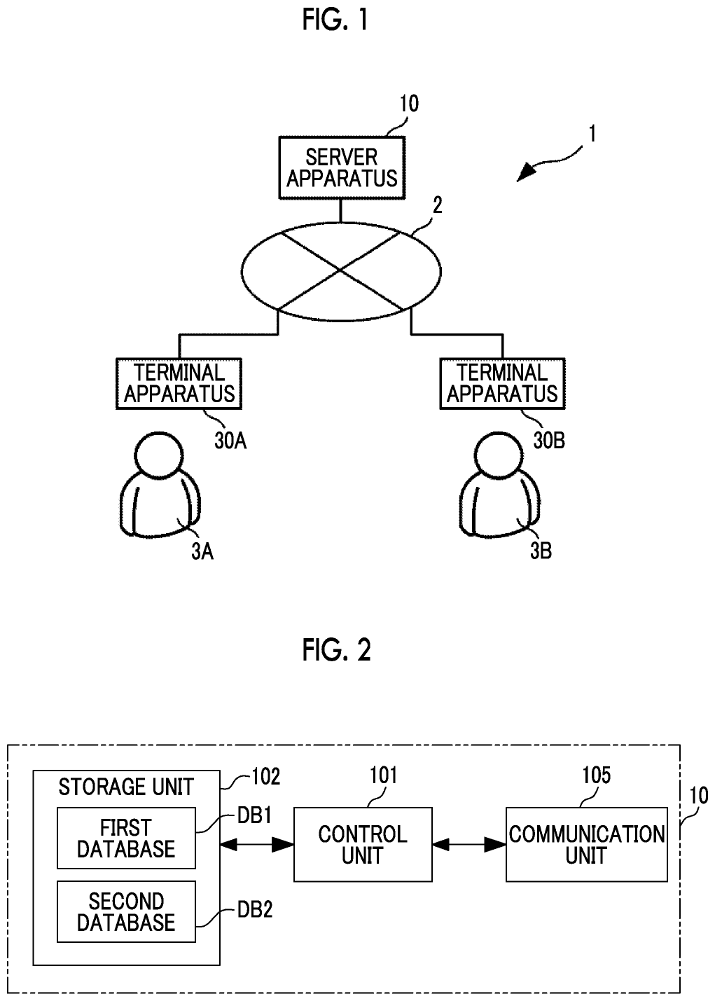

FIG. 1 is a diagram illustrating apparatuses related to a talent search system 1 that is one exemplary embodiment of the present invention. The talent search system 1 is a system that stores information related to plural persons related to production of designs and searches for a person who produces a design similar to a design desired by the user. A communication link 2 is a communication network through which data communication is performed. Plural computer apparatuses that perform data communication are connected to the communication link 2. The communication link 2 includes wired and wireless communication networks.

Terminal apparatuses 30A and 30B are terminals used by the user of the talent search system 1. The terminal apparatus 30A is used by a user 3A, and the terminal apparatus 30B is used by a user 3B. In the exemplary embodiment, each of the terminal apparatuses 30A and 30B is a desktop personal computer. However, each of the terminal apparatuses 30A and 30B is not limited to a desktop personal computer and may be a laptop personal computer, a smartphone, a tablet terminal, a feature phone, or the like. The terminal apparatuses 30A and 30B perform data communication and access a server apparatus 10 through the communication link 2. In FIG. 1, while the terminal apparatuses 30A and 30B are illustrated, the talent search system 1 may be configured to include three or more terminal apparatuses.

The server apparatus 10 is connected to the communication link 2. The server apparatus 10 is one example of an information processing apparatus according to an exemplary embodiment of the present invention. For example, the server apparatus 10 stores information related to a person who produces an artwork in the field of design, and information related to the artwork produced by the person. The server apparatus 10 searches for a person providing an artwork similar to the artwork desired by the user using the stored information and presents information related to a person hit by the search to the user.

Configuration of Server Apparatus 10

FIG. 2 is a block diagram illustrating one example of a hardware configuration of the server apparatus 10. A communication unit 105 is a communication interface for communication through the communication link 2. A storage unit 102 includes a storage apparatus (for example, a hard disk apparatus) storing information and stores a program executed by a control unit 101. The storage unit 102 is one example of a storage section according to the exemplary embodiment of the present invention. In addition, the storage unit 102 stores a first database DB1 and a second database DB2.

The first database DB1 is a database that stores information related to a person producing an artwork in the field of design. For example, the first database DB1 stores a name, an address, a mail address, an education history, a work history, an award history, the artwork name of the produced artwork, an image of the produced artwork, and a description of the produced artwork for each of plural persons managed by the server apparatus 10. The information stored in the first database DB1 is not limited to such information. For example, information related to a photograph of the managed person, a URL of the artwork, a person who commissions the artwork, and a contest where the artwork is published may be stored.

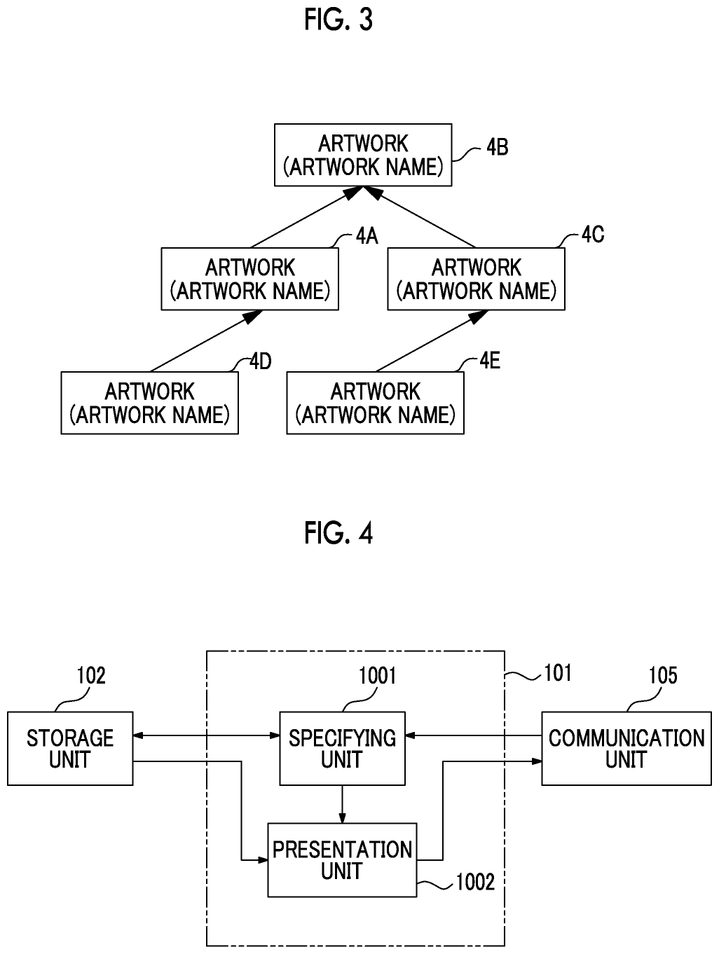

The second database DB2 is a database that stores a connection relationship as a graph structure between artworks produced by a person having a name stored in the first database. FIG. 3 is a diagram for describing the graph structure stored in the second database DB2. In the graph structure stored in the second database DB2, a node includes an artwork name and represents an artwork, and an edge that represents a connection relationship between artworks represents a reference relationship between the artworks. For example, in the graph structure illustrated in FIG. 3, an artwork 4A is connected toward an artwork 4B by an edge. Thus, this connection means that the artwork 4A is produced with reference to the artwork 4B. An artwork 4C is also connected toward the artwork 4B by an edge. Thus, this connection means that the artwork 4C is produced with reference to the artwork 4B. In a case where one reference artwork is present for plural artworks, the one artwork and the plural artworks maybe connected to each other by edges . In a case where plural reference artworks are present for one artwork, the one artwork and the plural reference artworks may be connected to each other by edges.

Functional Configuration of Server Apparatus 10

FIG. 4 is a function block diagram illustrating functions implemented by causing the control unit 101 to execute the program. A specifying unit 1001 specifies an artwork in a connection relationship with an artwork selected by the user among plural artworks from the graph structure stored in the second database DB2. The specifying unit 1001 is one example of a specifying section according to the exemplary embodiment of the present invention. A presentation unit 1002 ranks the artist of the artwork specified by the specifying unit 1001 and presents the ranking result to the user of the talent search system 1. The presentation unit 1002 is one example of a presentation section according to the exemplary embodiment of the present invention.

Operation Example of Exemplary Embodiment

Next, an operation example of the exemplary embodiment will be described. In the following description, an operation example when the user 3B who is the producer of an artwork registers information related to the user 3B and information related to the artwork produced by the user 3B in the server apparatus 10 will be described first, and an operation example when the user 3A of the talent search system 1 searches for a candidate of a person to produce the artwork desired by the user 3A will be described next.

The user 3B who is the producer of an artwork starts a Web browser in the terminal apparatus 30B and accesses the server apparatus 10 using the started Web browser. The server apparatus 10 that is accessed from the terminal apparatus 30B transmits data of a Web page as a top page among Web pages provided by the server apparatus 10 to the terminal apparatus 30B. In a case where the terminal apparatus 30B receives the data of the top page, the terminal apparatus 30B displays the top page indicated by the received data.

In the displayed Web page, in a case where the user 3B operates a link to a Web page for registering information related to the producer of an artwork, the terminal apparatus 30B transmits a request for the Web page indicated by the operated link to the server apparatus 10. In response to the transmitted request, the server apparatus 10 transmits data of the Web page for registering information related to the producer of an artwork to the terminal apparatus 30B. In a case where the terminal apparatus 30B receives the data of the Web page for registering information related to the producer of an artwork, the terminal apparatus 30B displays the Web page indicated by the received data.

For example, the Web page for registering information related to the producer of an artwork includes plural text boxes for inputting a name, an address, a photograph of a person, a mail address, an education history, a work history, and an award history as a graphical user interface (GUI) for inputting information related to the producer of an artwork. In a case where the user 3B inputs the name, the address, the mail address, the education history, the work history, and the award history of the user 3B into the displayed text boxes and performs an operation of a registration instruction, the terminal apparatus 30B transmits the information input into the text boxes to the server apparatus 10. In a case where the server apparatus 10 receives the information transmitted from the terminal apparatus 30B, the server apparatus 10 stores the received information in the first database DB1.

Next, in a case where the user 3B operates a link to a Web page for registering information related to the artwork of the user 3B, the terminal apparatus 30B transmits a request for the Web page indicated by the operated link to the server apparatus 10. In response to the transmitted request, the server apparatus 10 transmits data of the Web page for registering information related to the artwork to the terminal apparatus 30B. In a case where the terminal apparatus 30B receives the data of the Web page for registering information related to the artwork, the terminal apparatus 30B displays the Web page indicated by the received data.

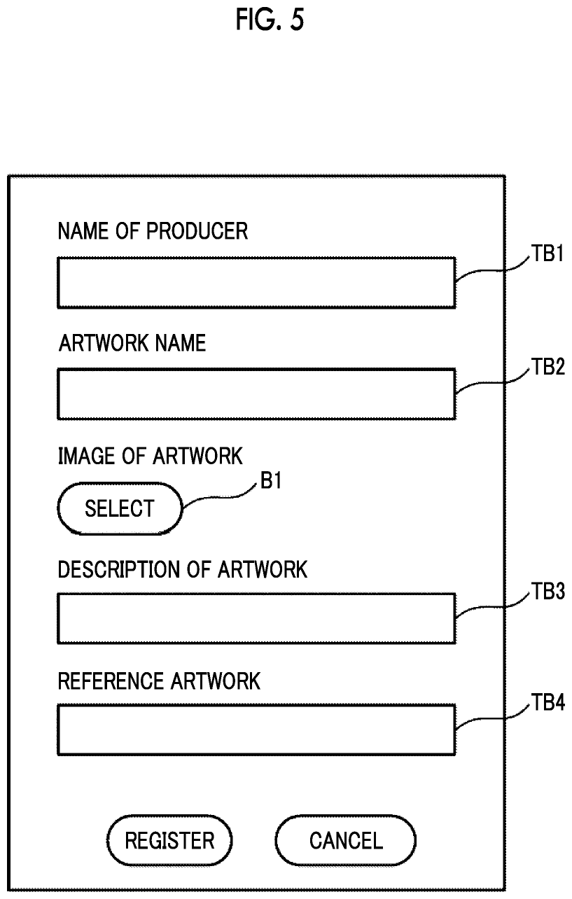

FIG. 5 is a diagram illustrating one example of the Web page for registering information related to the artwork. The Web page for registering information related to the artwork includes a graphical user interface (GUI) for inputting information related to the artwork. A text box TB1 in FIG. 5 is a text box for inputting the name of the producer of the artwork to be registered. A text box TB2 in FIG. 5 is a text box for inputting the artwork name of the produced artwork. A button B1 in FIG. 5 is a GUI for selecting a file of an image of the produced artwork. In a case where an operation of clicking the button B1 is performed, a GUI for selecting a file is displayed. The user selects an image file of the produced artwork in the GUI for selecting a file. A text box TB3 is a text box for inputting a description of the produced artwork. A text box TB4 is a text box for inputting the artwork name of another reference artwork at the time of producing the artwork to be registered. The user 3B inputs the name of the user 3B, the artwork name of the produced artwork, a description of the produced artwork, and the artwork name of the reference artwork at the time of production, selects a file of an image of the artwork, and then, performs an operation of clicking a registration button. Ina case where an operation of clicking the registration button is performed, the terminal apparatus 30B transmits the information input into the text boxes TB1 to TB4 and the selected image file of the artwork to the server apparatus 10.

In a case where the server apparatus 10 receives the information and the image file transmitted from the terminal apparatus 30B, the server apparatus 10 searches for a record storing the name included in the received information in the first database DB1. In a case where a record that stores the name included in the received information is hit, the server apparatus 10 stores the artwork name of the produced artwork, the file name of the image file, and the description of the produced artwork transmitted from the terminal apparatus 30B as a set in the hit record and stores the received image file in the storage unit 102.

In addition, the server apparatus 10 updates the second database DB2 using the artwork name of the produced artwork and the artwork name of the reference artwork transmitted from the terminal apparatus 30B. Specifically, the server apparatus 10 generates a node of an artwork that includes the artwork name of the produced artwork. Next, the server apparatus 10 searches for anode that includes the artwork name of the reference artwork, generates an edge that connects the node including the artwork name of the produced artwork to the node hit by the search, and stores the updated graph structure in the second database DB2.

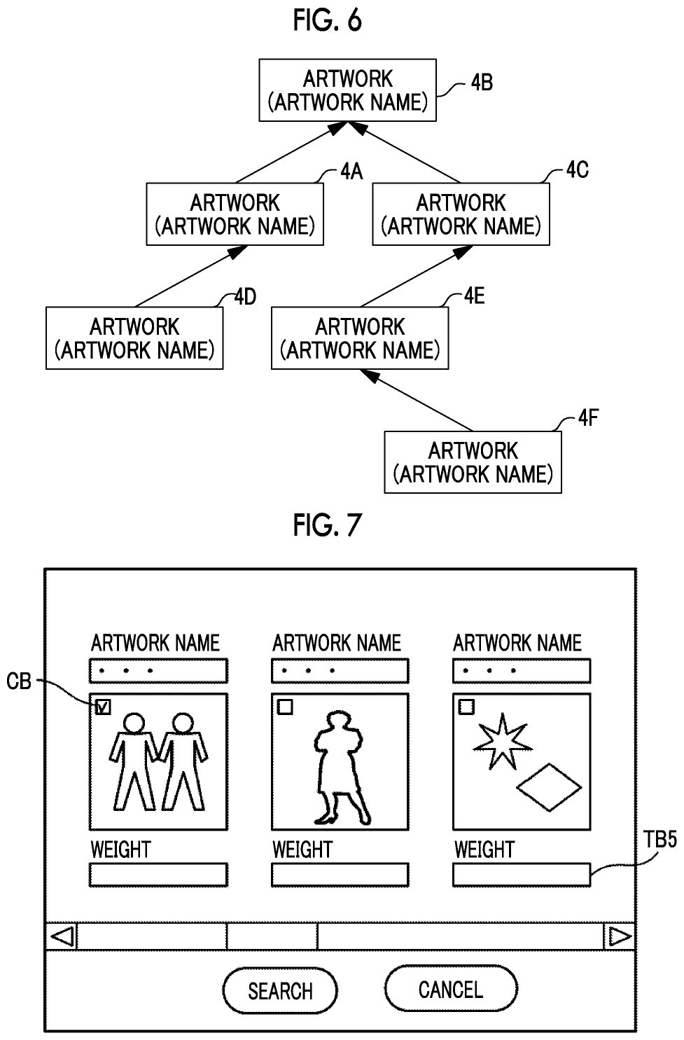

For example, when the graph structure in FIG. 3 is stored in the second database DB2, in a case where the artwork name of a new artwork 4F is received, and the artwork name of an artwork 4E as the artwork name of the reference artwork in production of the artwork 4F is received, the graph structure stored in the second database DB2 is updated to a graph structure such that a node of the artwork 4F is added, and an edge toward the artwork 4E from the artwork 4F is added as illustrated in FIG. 6.

Next, an operation example when the user 3A of the terminal apparatus 30A searches for a person who produces a design similar to the design desired by the user 3A will be described. The user 3A starts a Web browser in the terminal apparatus 30A and accesses the server apparatus 10 using the started Web browser. The server apparatus 10 that is accessed from the terminal apparatus 30A transmits data of the Web page as the top page among the Web pages provided by the server apparatus 10 to the terminal apparatus 30A. In a case where the terminal apparatus 30A receives the data of the top page, the terminal apparatus 30A displays the top page indicated by the received data.

In the displayed Web page, in a case where the user 3A operates a link to a Web page for searching for a person, the terminal apparatus 30A transmits a request for the Web page indicated by the operated link to the server apparatus 10. In response to the transmitted request, the server apparatus 10 transmits data of the Web page for searching for a person to the terminal apparatus 30A. In a case where the terminal apparatus 30A receives the data of the Web page for searching for a person, the terminal apparatus 30A displays the Web page indicated by the received data.

FIG. 7 is a diagram illustrating one example of the Web page for searching for a person. In the Web page for searching for a person, the artwork name of the artwork registered in the first database DB1 and the image of the artwork stored in the storage unit 102 are displayed. In addition, in the Web page for searching for a person, a checkbox CB for selecting an artwork and a text box TB5 for inputting a weight of an artwork are disposed in association with the artwork name of the artwork.

In the displayed Web page, the user 3A enters a check into the checkbox CB of an artwork similar to the artwork desired by the user 3A and inputs a numerical value indicating a weight into the text box TB5. In the exemplary embodiment, the numerical value that indicates a weight is input as a positive integer. In a case where there are plural artworks similar to the artwork desired by the user 3A, the user 3A enters a check into the checkbox CB and inputs a numerical value indicating a weight into the text box TB5 for each of the plural artworks. A higher numerical value of weight represents an artwork that is more similar to the artwork desired by the user 3A. In a case where the user 3A finishes selecting an artwork similar to the artwork desired by the user 3A, the user 3A performs an operation of clicking a search button. In a case where an operation of clicking the search button is performed, the terminal apparatus 30A transmits, to the server apparatus 10, the artwork name associated with the checkbox into which a check is entered, and the value of weight input into the text box TB5 associated with the checkbox into which a check is entered. The numerical value of weight is not limited to a positive integer. The range of the numerical value of weight may be 0<weight≤1.

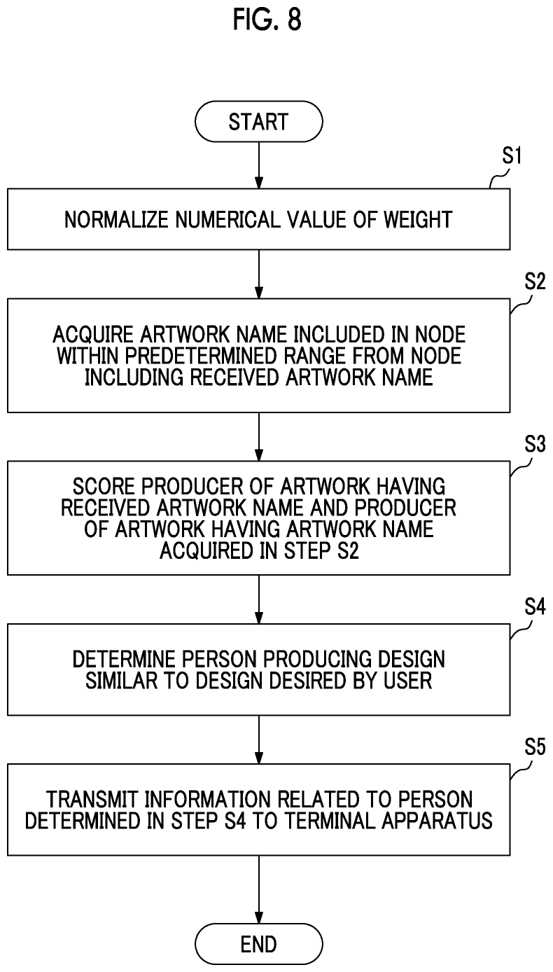

The server apparatus 10 receives the artwork name and the numerical value of weight transmitted from the terminal apparatus 30A and performs a search process using the received information. FIG. 8 is a flowchart illustrating a flow of search process performed by the server apparatus 10. First, the server apparatus 10 normalizes the received numerical value of weight within a range of 0<weight≤1 (step S1). The process of normalizing the weight may use a softmax function. In a case where the range of the weight input in the Web page is set to 0<weight≤1 as described above, the server apparatus 10 does not perform the process of step Si.

Next, with reference to the second database DB2, the server apparatus 10 (specifying unit 1001) acquires an artwork name included in a node within a predetermined range through edges from a node including the received artwork name (step S2). For example, in a case where the graph structure stored in the second database DB2 is the graph structure illustrated in FIG. 6, and the artwork having the received artwork name corresponds to the artwork 4D and the artwork 4F, the server apparatus 10 acquires the artwork name of the artwork 4A that is the node connected by an edge from the artwork 4D, and also acquires the artwork name of the artwork 4B that is the node connected by an edge from the artwork 4A. In addition, the server apparatus 10 acquires the artwork name of the artwork 4E that is the node connected by an edge from the artwork 4F, and also acquires the artwork name of the artwork 4C that is the node connected by an edge from the artwork 4E. In the exemplary embodiment, while the predetermined range is up to the second node reached through edges from the node having the received artwork name, the predetermined range may be a range up to the third or later node. The predetermined range may be specified by the user searching for a person, and the server apparatus 10 may set the range specified by the user as the predetermined range.

Next, the server apparatus 10 scores the producer of the artwork having the received artwork name and the producer of the artwork having the artwork name acquired in step S2 (step S3). Specifically, the server apparatus 10 acquires the name of the artist associated with the received artwork name from the first database DB1, scores the artwork having the received artwork name using an expression “score of artwork=number of hops×(1−normalized weight of artwork having received artwork name)”, and sets the score as the score of the artist of the artwork having the received artwork name. In addition, the server apparatus 10 acquires the name of the artist associated with the artwork name acquired in step S2 from the first database DB1, scores the artwork having the artwork name acquired through edges from the artwork having the received artwork name using the expression “score of artwork=number of hops33 (1−normalized weight of artwork having received artwork name)”, and sets the score as the score of the artist of the artwork having the artwork name acquired through edges from the artwork having the received artwork name.

The number of hops is a number that indicates the ordinal number of a node reached through edges from a node as a starting point with the first node as the node as the starting point at the time of acquiring the artwork name in step S2. The number of hops is one when the artwork having the received artwork name is scored. For example, the node as the starting point at the time of acquiring the artwork name in step S2 is the artwork 4D. The artwork 4A is the first node reached from the artwork 4D. Thus, the number of hops at the time of scoring the artwork 4D is two. The artwork 4B is the second node reached from the artwork 4D. Thus, the number of hops for the artwork 4B is three.

For example, in a case where a value acquired by normalizing the acquired weight is 0.9 for the artwork 4D, the score of the producer of the artwork 4D is 0.1 from score of artwork 4D=1×(1−0.9)=0.1. For the artwork 4A, the score of the producer of the artwork 4A is 0.2 from score of artwork 4A=2×(1−0.9). For the artwork 4B, the score of the producer of the artwork 4B is 0.3 from score of artwork 4B=3×(1−0.9). In a case where a value acquired by normalizing the acquired weight is 0.7 for the artwork 4F, the score of the producer of the artwork 4F is 0.3 from score of artwork 4F=1×(1−0.7)=0.3. For the artwork 4E, the score of the producer of the artwork 4E is 0.6 from score of artwork 4E=2×(1−0.7). For the artwork 4C, the score of the producer of the artwork 4C is 0.9 from score of artwork 4C=3×(1−0.7).

In a case where scoring of the producer of the artwork having the received artwork name and the producer of the artwork having the artwork name acquired in step S2 is finished, the server apparatus 10 determines a person who produces a design similar to the design desired by the user 3A (step S4). Specifically, the server apparatus 10 determines that a producer having the lowest score is a person who produces a design similar to the design desired by the user 3A. In the above example, the score of the producer of the artwork 4D is the lowest. Thus, it is determined that the producer of the artwork 4D is a person who produces a design similar to the design desired by the user 3A. In a case where plural artwork names are acquired for one producer as a result of step S2, the server apparatus 10 in the exemplary embodiment sets the lowest score as the score of the producer among the scores given to the artworks having the acquired plural artwork names.

Next, the server apparatus 10 (presentation unit 1002) transmits information related to the person determined in step S4 to the terminal apparatus 30A (step S5) . The server apparatus 10 searches in the first database DB1 for a record storing the name of the person determined in step S4 and extracts information stored in the record hit by the search. As the information related to the person producing a design similar to the design desired by the user 3A, the server apparatus 10 generates a Web page including the name of the person determined in step S4 and the information extracted from the first database DB1 and transmits data of the generated Web page to the terminal apparatus 30A. In the above example, the person who produces a design similar to the design desired by the user 3A is the producer of the artwork 4D. Thus, the server apparatus 10 transmits a Web page including a name, an address, a mail address, an education history, a work history, an award history, the artwork name of a produced artwork, an image of a produced artwork, and a description of a produced artwork for the producer of the artwork 4D.

In a case where the terminal apparatus 30A receives the data of the Web page transmitted from the server apparatus 10, the terminal apparatus 30A displays the Web page indicated by the received data. In the displayed Web page, the name, the address, the mail address, the education history, the work history, the award history, the artwork name of the produced artwork, the image of the produced artwork, and the description of the produced artwork of the producer of the artwork 4D are displayed as the information related to the person producing a design similar to the design desired by the user 3A.

### Modification Example

While the exemplary embodiment of the present invention is described thus far, the present invention is not limited to the above exemplary embodiment and may be embodied in various other forms. For example, the present invention may be embodied by modifying the above exemplary embodiment as described below. The above exemplary embodiment and the following modification example may be combined with each other.

In the above exemplary embodiment, the talent search system 1 is configured to store information related to plural persons related to production of designs and search for a person producing a design similar to the design desired by the user, the field related to the searched person is not limited to the field of design. For example, in the fields of drawing, sculpture, building, music, and movie, information related to a producer and an artwork may be stored in the first database DB1, and a connection relationship between artworks may be stored in the second database DB2 as a graph structure. In those fields, a person who produces an artwork desired by the user may be searched.

In the above exemplary embodiment, in the graph structure stored in the second database DB2, an edge that connects nodes represents a reference relationship between artworks. However, nodes that are in the same field at the time of categorizing artworks may be correlated with each other by an edge. In addition, for example, nodes of artworks having the same theme may be correlated with each other by an edge, or nodes of artworks having the same subject matter may be correlated with each other by an edge. The artworks in the same field are one example of artworks of the same type according to the exemplary embodiment of the present invention. The artworks having the same theme are also one example of the artworks of the same type according to the exemplary embodiment of the present invention.

In the above exemplary embodiment, the user inputs the artwork name of the reference artwork into the text box at the time of registering information related to the artwork. However, in the exemplary embodiment of the present invention, a GUI that includes the text boxes TB1 to TB3 and the button B1 may be displayed as a GUI for registering the reference artwork, and information related to the reference artwork may be registered. In addition, in the exemplary embodiment according to the present invention, in a case where information related to the artwork is registered, a screen of a GUI for searching for the reference artwork may be disposed, and an artwork may be searched using a keyword. The reference artwork may be selected from the artworks hit by the search.

In the above exemplary embodiment, the artwork name of the reference artwork is input at the time of registering information related to the artwork. However, for example, the reference artwork may be in the same field as the produced artwork or may be in a contrasting field different from the field of the produced artwork. For example, information related to the field of the artwork may be included in the node in the second database DB2. When the artwork name included in the node within the predetermined range through edges from the node including the received artwork name is acquired in step S2, the producer of the artwork of the node reached through edges may be excluded from the target for scoring in step S3 in a case where the artwork of the node connected by edges is in a contrasting field. For example, an example of contrasting fields is the field of realistic artworks with respect to the field of abstract artworks. In addition, even in a case where the fields of the artworks of the nodes connected by edges are different from each other, the producer of the artwork of the node reached through edges may be excluded from the target for scoring in step S3. In addition, for example, in the second database DB2, information related to the field of the artwork may be included in the node, and an edge that connects nodes may not connect nodes of artworks in different fields or nodes of artworks in contrasting fields.

In the above exemplary embodiment, while information related to one person as a person producing a design similar to the design desired by the user is presented on the Web page, information related to plural producers may be presented by sorting scores given to the producers in ascending order and presenting information related to the producers having scores within a predetermined range from the lowest score to the user on the Web page.

In the exemplary embodiment of the present invention, the expression for scoring the artwork is not limited to the expression described in the exemplary embodiment. For example, the work history or the award history of the artist of the artwork may be weighted, and scoring may be performed using an expression that includes the weight given to the work history or the award history. In addition, the user may select the item of information to be added at the time of weighting, and scoring may be performed using an expression that includes the weight set for the item selected by the user.

A program of each apparatus according to the exemplary embodiment of the present invention may be provided in a state where the program is stored in a computer readable recording medium such as a magnetic recording medium (a magnetic tape, a magnetic disk (a hard disk drive (HDD), a flexible disk (FD), or the like), an optical recording medium (an optical disc or the like), a magneto-optical recording medium, or a semiconductor memory and may be installed. The program may be downloaded through a communication link and may be installed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage section that stores artwork information related to each of a plurality of artworks and a connection relationship among the plurality of artworks;
a specifying section that specifies an artwork in the connection relationship with an artwork selected by a user among the plurality of artworks from the relationship stored in the storage section; and
a presentation section that ranks an artist of the artwork specified by the specifying section and presents a result of ranking.

2. The information processing apparatus according to claim 1,
wherein the specifying section specifies an artwork that is within a predetermined range through the connection relationship from the artwork selected by the user.

3. The information processing apparatus according to claim 2,
wherein the range is specified by the user.

4. The information processing apparatus according to claim 1,
wherein among the plurality of artworks, a reference artwork and a referenced artwork are connected.

5. The information processing apparatus according to claim 4,
wherein the presentation section does not present an artist of an artwork for which a field to which the artwork belongs is in a contrasting relationship.

6. The information processing apparatus according to claim 1,
wherein artworks of the same type are connected.

7. The information processing apparatus according to claim 1,
wherein the presentation section ranks the artist of each artwork specified by the specifying section based on a score that is given using a predetermined expression.

8. A non-transitory computer readable medium storing a program causing a computer to function as:
a storage section that stores artwork information related to each of a plurality of artworks and a connection relationship among the plurality of artworks;
a specifying section that specifies an artwork in the connection relationship with an artwork selected by a user among the plurality of artworks from the relationship stored in the storage section storing the artwork information related to each of the plurality of artworks and the connection relationship among the plurality of artworks; and
a presentation section that ranks an artist of the artwork specified by the specifying section and presents a result of ranking.

9. An information processing apparatus comprising:
storage means for storing artwork information related to each of a plurality of artworks and a connection relationship among the plurality of artworks;
specifying means for specifying an artwork in the connection relationship with an artwork selected by a user among the plurality of artworks from the relationship stored in the storage means; and
presentation means for ranking an artist of the artwork specified by the specifying means and presenting a result of ranking.
